(19) United States
(12) Patent Application Publication
(10) Pub. No.: US 2003/0201687 A1
(43) Pub. Date: Oct. 30, 2003

(54) Stator for an electric rotary machine

(75) Inventor: Jiro Asai, Okazaki-shi (JP)

Correspondence Address: OLIFF & BERRIDGE, PLC, P.O. BOX 19928, ALEXANDRIA, VA, 22320, US

(73) Assignee: Denso Corporation, Kariya-City (JP)

(21) Appl. No.: 10/421,881

(22) Filed: Apr. 24, 2003

(30) Foreign Application Priority Data
Apr. 26, 2002 (JP) 2002-125663

(51) Int. Cl. H02K 3/48; H02K 1/00

(52) U.S. Cl. 310/214; 310/254; 310/216

(57) ABSTRACT

A stator core has slot closures formed at radial inner ends of slots. The slot closures, extending in the circumferential direction from radial inner ends of respective teeth, substantially isolate the slots from an electromagnetic gap (g). A plurality of conductor segments are inserted into the slots, with ends of the conductor segments being sequentially connected at an axially outside of the stator core.

### BACKGROUND OF THE INVENTION

The present invention relates to a stator for an electric rotary machine which is constituted by electromagnetic laminated steel sheets so as to have soft magnetic properties.

A stator core for an electric rotary machine has teeth and slots alternately arranged in the circumferential direction and disposed in the vicinity of an inner cylindrical surface thereof facing a rotor via an electromagnetic gap. Respective slots are opened to the inner cylindrical surface of the stator core, with teeth claws extending in the circumferential direction from the inner radial ends of neighboring teeth so as to narrow the slot opening, for the purpose of solving various problems relating to the magnetic resistance of the electromagnetic gap or in the vicinity of the inner cylindrical surface of the stator core, and its variation, or distortion in the magnetic flux distribution, as well as the derivative problems including torque variation and noises derived from these problems. In this case, a circumferential width of the slot opening needs to be wider than the width of a conductor of a stator coil to be inserted into the slots of the stator core. Furthermore, it is needless to say that removing the teeth claws is advantageous in facilitating the work for inserting or installing the stator coil into the slots.

However, securing a sufficient circumferential width of the slot opening is canceling the effect of improving the above-described problems relating to the magnetic resistance of the electromagnetic gap or in the vicinity of the inner cylindrical surface of the stator core, and its variation, or distortion in the magnetic flux distribution.

To solve this contradiction, the Japanese Patent Application Laid-open No. 6-113493(1994) proposes adopting a plug of electromagnetic steel sheets laminated in the circumferential direction to close the slot opening. Furthermore, the Japanese Patent Application Laid-open No. 10-51987(1998) or No. 2000-60036 proposes placing an additional ring-shaped member along the inner cylindrical surface of the stator core to close the slot opening after the stator coil is installed into the slots. Furthermore, the Japanese Patent Application Laid-open No. 10-234159(1998) proposes dividing the stator core into two pieces to facilitate the work for inserting or installing the stator coil into the slots and to provide the slots sufficiently narrowed or closed at the radial inner side.

Furthermore, the applicant of this invention has already proposed a stator coil manufacturing technique using numerous U-shaped conductor segments respectively inserted into the slots from the axial direction and sequentially connected at axial ends thereof (refer to Japanese Patent Application Laid-open No. 2000-92766).

Furthermore, regarding the method of forming the stator core by using electromagnetic steel sheets, laminating ordinary ring-shaped electromagnetic steel sheets in the axial direction is already known and also rolling or winding a tape-like elongated electromagnetic steel sheet with slots and teeth formed along its longitudinal edge is also known.

However, all of the above-described conventional stator cores are based on a plurality of magnetic permeable members (e.g., electromagnetic steel sheets). The manufacturing processes are complicated. The magnetic resistance at the clearances formed between the magnetic permeable members is large. The mechanical rigidity of the stator core is low.

### SUMMARY OF THE INVENTION

In view of the foregoing problems of the prior arts, an object of the present invention is to provide a stator core for an electric rotary machine which is capable of providing excellent slots sufficiently narrowed or closed at the radial inner side without complicating the manufacturing processes or increasing the magnetic resistance while maintaining the mechanical rigidity.

To accomplish the above and other related objects, the present invention provides a stator for an electric rotary machine including a stator core and a stator coil. The stator core has slots and teeth alternately arranged in a circumferential direction and disposed in the vicinity of an inner cylindrical surface of the stator core which faces a rotor with a predetermined electromagnetic gap. The stator coil is wound around the stator core and inserted into the slots. The stator core includes slot closures integrally formed with the teeth and extending in the circumferential direction from radial inner ends of respective teeth so as to substantially isolate the slots from the electromagnetic gap. And, the stator coil includes a plurality of conductor segments inserted into the slots, with ends of the conductor segments being sequentially connected at an axially outside of the stator core.

According to the stator of the present invention, it is not necessary to separate or divide the stator core into two or more pieces to install the stator coil.

More specifically, according to the stator of the present invention, insertion or installation of the conductor segments is performed in the axial direction of the slots, not in the radial direction. Accordingly, the work for installing or inserting the stator coil requires no slot opening opened at the radial inner end of respective slots. In other words, using numerous conductor segments respectively inserted into the slots in the axial direction and sequentially connected at axial ends thereof makes it possible to omit the slot opening of respective slots which was conventionally required to continuously wind a stator coil.

In this specification, the “slot closures integrally formed with the teeth and extending in the circumferential direction from radial inner ends of respective teeth so as to substantially isolate the slots from the electromagnetic gap” includes a slot closure which is constituted by a pair of claws brought into contact with their distal ends with no clearance between them.

According to a preferable embodiment of the present invention, the slot closures and the teeth are integrally formed by using the same material and completely isolate the slots from the electromagnetic gap.

According to a preferable embodiment of the present invention, a radial size of the slot closures decreases with approaching distance from a circumferential end of respective slots toward a circumferential center of the slots. With this arrangement, it becomes possible to suppress the leakage of magnetic flux caused by a stator coil current which may pass the slot closure 103.

According to a preferable embodiment of the present invention, a thickness of the slot closures in the radial direction is less than a clearance of the electromagnetic gap. With this arrangement, it becomes possible to reduce a magnetic deviation caused by an armature reaction.

The stator of an electric rotary machine of this invention can be used for an inner rotor structure or for an outer rotor structure.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a vertical cross-sectional view showing an automotive alternator in accordance with a preferred embodiment of the present invention;

FIG. 2 is a perspective view schematically showing conductor segments serving as part of a stator coil shown in FIG. 1;

FIG. 3 is a cross-sectional view showing the conductor segments accommodated in each slot of the stator core shown in FIG. 1;

FIG. 4 is a perspective view schematically showing the conductor segments and the slots of the stator core into which the conductor segments are installed;

FIG. 5 is a vertical cross-sectional view schematically showing a twist shaping unit;

FIG. 6 is a plan view showing twisting jigs of the twist shaping unit shown in FIG. 5, taken along a line A-A of FIG. 5;

FIG. 7 is a radial development view partially showing the stator coil manufactured by the twist shaping unit;

FIG. 8 is a front view partially showing the stator coil of FIG. 7;

FIG. 9 is a cross-sectional view schematically showing a process for installing an inclined L-shaped conductor segment into a slot of the stator core and bending distal end thereof;

FIG. 10 is a cross-sectional view schematically showing a process for installing an I-shaped conductor segment into the slot of the stator core and bending distal ends thereof,

FIG. 11 is a side view of a stator core having slots each completely isolated from an electromagnetic gap;

FIG. 12 is an enlarged side view showing an essential part of the stator core shown in FIG. 11;

FIG. 13 is an enlarged side view showing a modified embodiment of the stator core shown in FIG. 12;

FIG. 14 is an enlarged side view showing another modified embodiment of the stator core shown in FIG. 12;

FIG. 15 is an enlarged side view showing another modified embodiment of the stator core shown in FIG. 12; and

FIG. 16 is an enlarged side view showing another modified embodiment of the stator core shown in FIG. 12.

### DESCRIPTION OF THE PREFERRED EMBODIMENTS

Preferred embodiments of the present invention will be explained hereinafter with reference to attached drawings.

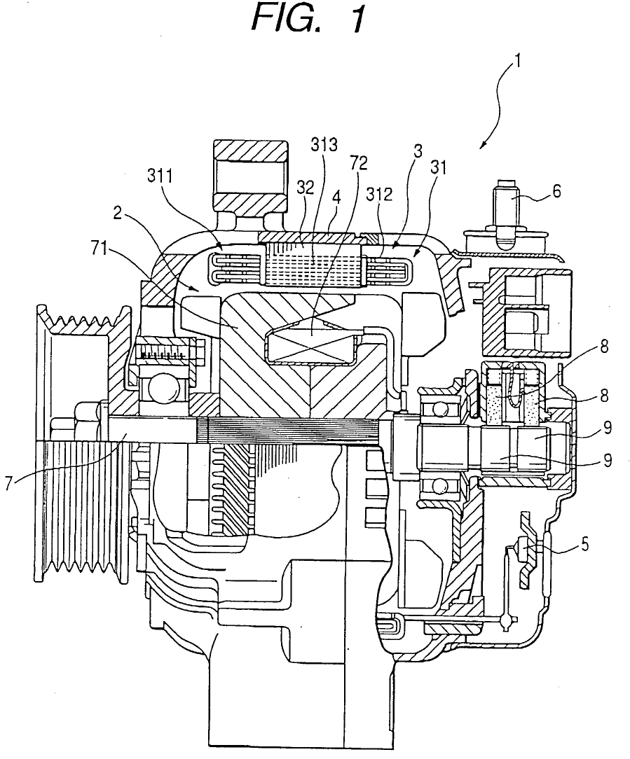

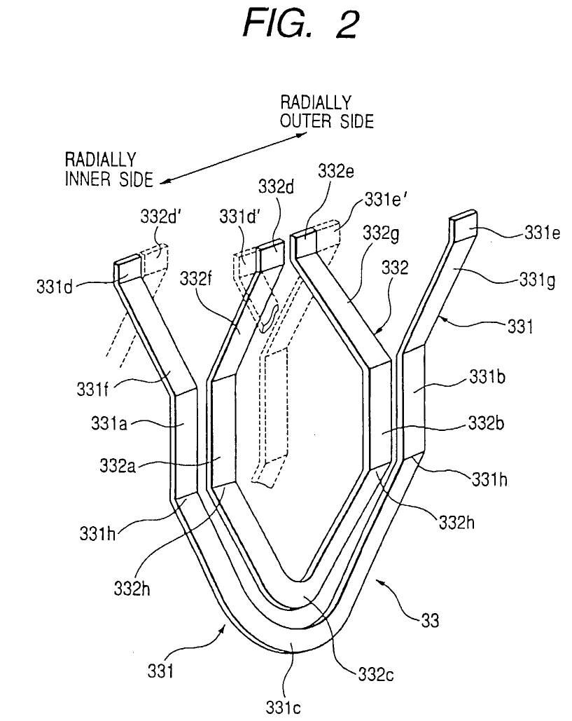

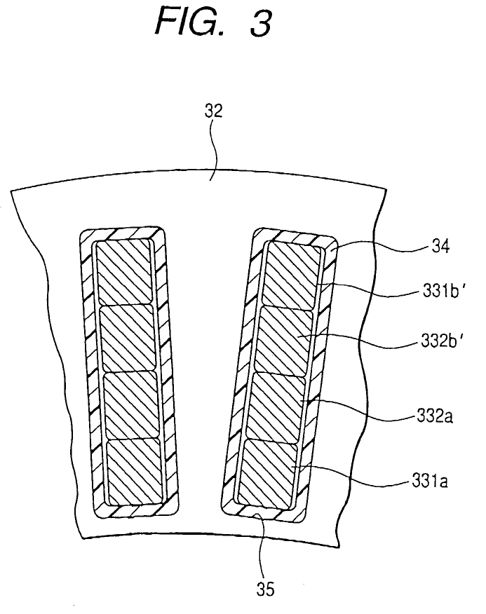

Hereinafter, an automotive alternator in accordance with a preferred embodiment of the present invention and its manufacturing method will be explained with reference to attached drawings. FIG. 1 is a vertical cross-sectional view showing an automotive alternator in accordance with a preferred embodiment of the present invention. FIG. 2 is a perspective view showing conductor segments serving as part of a stator coil. FIG. 3 is a cross-sectional view showing the installed condition of conductor segments accommodated in each slot.

### Overall Arrangement

As shown in FIG. 1, an automotive alternator 1 includes a rotor 2, a stator 3, a housing 4, a rectifier 5, an output terminal 6, a rotary shaft 7, a brush 8, and a slip ring 9. The stator 3 includes a stator coil 31 and a stator core 32. The stator core 32, having high magnetic permeability, is fixed on an inner cylindrical wall of the housing 4. The stator coil 31 is wound in each slot of the stator core 32. The rotor 2 includes a Lundel-type rotor core 71 and a field coil 72. The Lundel-type rotor core 71 is fixed to the rotary shaft 7. The rotary shaft 7 is rotatably supported in the housing 4 which is stationary. The field coil 72 is wound around the rotor core 71. The rotor 2 is disposed radially inside the stator 3. The stator coil 31 is a three-phase armature winding which produces three-phase alternating-current voltages from its three alternating-current output terminals. The rectifier 5, constituting a three-phase full wave rectifying circuit, rectifies the three-phase alternating-current voltages produced from the stator coil 31. The field coil 72 is magnetized when it receives a field current supplied via the brush 8 and the slip ring 9. The magnetized field coil 72 generates a magnetic field. The field current supplied to the field coil 72 is generally adjusted by a regulator (not known) so as to maintain the generator voltage at a predetermined level. This kind of automotive alternator is conventionally well known in its structure and its operations. Therefore, no further detailed explanation for it will be necessary.

### Stator Coil 31

The stator coil 31 is constituted by a predetermined number of conductor segments 33 shown in FIG. 2. Each conductor segment 33, inserted into a slot of the stator core 32 from one side, extends in the slot and protrudes out of the stator core 32 from the other side. The protruding portion of the conductor segment 33, having a predetermined length, is twisted in the circumferential direction by an amount equivalent to an electric angle of π/2. The protruding portions of conductor segments 33 are welded at their distal ends according to predetermined combinations or pairings. Each conductor segment 33 has an elongated plate body configured as a whole into U shape which is sheath by a resin film except for the distal ends of the protruding portions, i.e., except for the distal end portions to be welded. This kind of stator coil itself, as characterized by sequentially connected conductor segments, is well known, too.

The detailed arrangement of conductor segment 33 is explained hereinafter.

The conductor segment 33 consists of a pentagonal, or U-shaped or V-shaped head conductor portion, a pair of in-slot conductor portions, and a pair of protruding tail conductor portions. The in-slot conductor portions extend straight and parallel to each other from bifurcated ends (i.e., bend points) of the head conductor portion. The protruding tail conductor portions extend outward from the corresponding in-slot conductor portions. In other words, the stator coil 31 consists of a first coil end portion (i.e., a head side coil end) 311, a second coil end portion (i.e., a tail side coil end) 312, and the in-slot conductor portions. The first coil end portion 311, formed as a whole into a ring shape, is disposed at one side of the stator core 32. The second coil end portion 312, formed as a whole into a ring shape, is disposed at the other side of the stator core 32. The in-slot conductor portions are disposed in the slots of the stator core 32. Namely, the first coil end portion 311 is constituted by the head conductor portions of the conductor segments 33, while the second coil end portion 312 is constituted by the protruding tail conductor portions of the conductor segments 33.

The conductor segment 33, as shown in FIG. 2, includes a large (turning) conductor segment 331 having a large turning head conductor portion and a small (turning) conductor segment 332 having a small turning head conductor portion.

The large turning conductor segment 331 consists of a head conductor portion 331c, a pair of in-slot conductor portions 331a and 331b, and a pair of protruding tail conductor portions 331f and 331g. The in-slot conductor portions 331a and 331b extend straight in parallel with each other and are continuous from both ends of the head conductor portion 331c. The boundary between the head conductor portion 331c and each in-slot conductor portion 331a or 331b is a bend point 331h. The protruding tail conductor portions 331f and 331g are continuous from the corresponding in-slot conductor portions 331a and 331b and have distal ends 331d and 331e which are portions to be welded. In this respect, the distal ends 331d and 331e can be also referred to as joint portions. The in-slot conductor portion 331a is positioned in the innermost layer. The in-slot conductor portion 331b is positioned in the outermost layer.

The small turning conductor segment 332 consists of a head conductor portion 332c, a pair of in-slot conductor portions 332a and 332b, and a pair of tail conductor portions 332f and 332g. The in-slot conductor portions 332a and 332b extend straight in parallel with each other and are continuous from both ends of the head conductor portion 332c. The boundary between the head conductor portion 332c and each in-slot conductor portion 332a or 332b is a bend point 332h. The tail conductor portions 332f and 332g are continuous from the corresponding in-slot conductor portions 332a and 332b and have distal ends 332d and 332e which are portions to be welded. In this respect, the distal ends 332d and 332e can be also referred to as joint portions. The in-slot conductor portion 332a is positioned in the inner middle layer. The in-slot conductor portion 332b is positioned in the outer middle layer.

Regarding the symbol ′ attached to numerals in the drawing, it means that a portion accompanied by the symbol ′ is identical with the portion denoted by the same reference numeral. Accordingly, in FIG. 2, the joint portions 331d and 332d′, which are aligned next to each other in the radial direction, are welded together. Similarly, the joint portions 332d and 331d′, which are aligned next to each other in the radial direction, are welded together. The joint portions 332e and 331e′, which are aligned next to each other in the radial direction, are welded together.

According to FIG. 2, the in-slot conductor portion 331a of the innermost layer and the in-slot conductor portion 332a of the inner middle layer are accommodated in a predetermined slot of the stator core 32. In this case, the other in-slot conductor portion 331b of the conductor segment 331, positioned in the outermost layer, is accommodated in a different slot of the stator core 32 which is angularly offset from that of the in-slot conductor portion 331a by an amount equivalent to a predetermined odd number of pole pitch T (according to this embodiment, one magnetic pole pitch (=electric angle of π)). The other in-slot conductor portion 332b of the conductor segment 332, positioned in the outer middle layer, is accommodated in the same slot as that of the in-slot conductor portion 331b of the conductor segment 331. The head conductor portion 331c of the large turning conductor segment 331 surrounds the head conductor portion 332c of the small turning conductor segment 332 in the condition where the conductor segments 331 and 332 are disposed in the slots of stator core 32.

FIG. 3 shows the layout of the conductor segments accommodated in the slots of stator core 32.

The in-slot conductor portion 331a of the innermost layer is disposed at a radially innermost end of the slot 35 of stator core 32. Disposed radially outer side with respect to the in-slot conductor portion 331a are successively, in this order, the in-slot conductor portion 332a of the inner middle layer, the in-slot conductor portion 332b′ of the outer middle layer, and the in-slot conductor portion 331b′ of the outermost layer. In short, each slot 35 accommodates a total of four in-slot conductor portions of four layers aligned in the radial direction. In FIG. 3, the in-slot conductor portion 332b′ belongs to a small turning conductor segment 332 which differs from the small turning conductor segment 332 having the in-slot conductor portion 332a. Similarly, the in-slot conductor portion 331b′ belongs to a large turning conductor segment 331 which differs from the large turning conductor segment 331 having the in-slot conductor portion 331a.

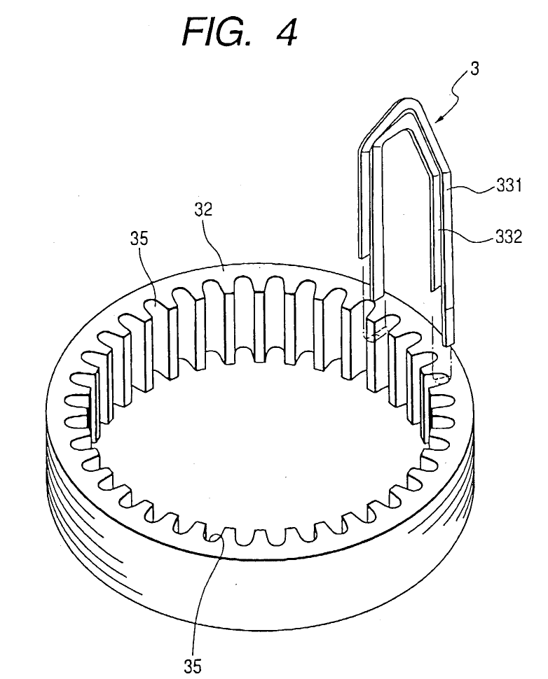

FIG. 4 shows the large turning conductor segment 331 and the small turning conductor segment 332 to be inserted into the slots 35. In FIG. 4, for the purpose facilitating the depiction, the slots 35 are illustrated as being cut along a virtual cylinder passing radial intermediate portions of respective slots 35.

### Manufacturing Method

1. Head Portion Twisting Process (i.e., U-Shaped Segment Forming Process)

First of all, the process for twisting the head conductor portion will be explained hereinafter.

A required number of conductor segments, each having a pine-needle shape, are prepared. Each prepared conductor segment has two elongated legs neighboring to each other and extending straight from its head being sharply bent. Next, each pine-needle conductor segment is configured into a U-shaped conductor segment with a pair of in-slot conductor portions angularly spaced by one pole pitch in the circumferential direction. Then, the U-shaped conductor segments are spatially disposed (more specifically, aligned in the circumferential direction) so that a required number of conductor segments are simultaneously inserted into each slot of the stator core. For the above-described process, it is possible to use a pair of coaxial rings having insertion holes, for example, disclosed in FIG. 3 of Japanese Patent No. 3118837. According to the manufacturing process shown in this prior art, both legs of a pine-needle conductor segment are inserted into two adjacent holes of the coaxial rings which are positioned in the same angular position. Then, the coaxial rings are mutually rotated about their axes by the amount corresponding to one pole pitch in the circumferential direction. As a result, each pine-needle conductor segment is configured into a V-shaped or U-shaped conductor segment with a head portion straddling so as to form, as a whole, a V shape or U shape in the circumferential direction.

According to this embodiment, the process of twisting the head conductor portion of a small turning conductor segment of a pine-needle shape is performed by using an inner middle layer ring and an outer middle layer ring which are coaxial with each other and rotatable in the circumferential direction to cause an angular shift between them. The inner middle layer ring has a radius corresponding to a radial position of the in-slot conductor portion of the inner middle layer. The inner middle layer ring has a predetermined number of insertion holes angularly arranged so as to correspond to respective in-slot conductor portions of the inner middle layer. Similarly, the outer middle layer ring has a radius corresponding to a radial position of the in-slot conductor portion of the outer middle layer. The outer middle layer ring has a predetermined number of insertion holes angularly arranged so as to correspond to respective in-slot conductor portions of the outer middle layer.

Installation of each small turning conductor segment of a pine-needle shape is performed in the following manner. First, the in-slot conductor portions of the inner middle layer are inserted into insertion holes of the inner middle layer ring. Then, the in-slot conductor portions of the outer middle layer are inserted into insertion holes of the outer middle layer ring. Next, the head portions of respective small turning conductor segments are fixed together with a holding plate to prevent them from rotating. Then, the inner middle layer ring and the outer middle layer ring are respectively rotated oppositely by a half pole pitch in the circumferential direction so as to cause an angular shift between them equivalent to one pole pitch. Through this twisting process, the small U-shaped turning conductor segment 332 is obtained as shown in FIG. 2. The holding plate, in this case, relocates in the axial direction as the apex of the head portion of each small turning conductor segment moves toward the side flat surfaces of the coaxial rings in accordance with deformation of the head portion when configured into the U shape from its original pine-needle shape.

Similarly, according to this embodiment, the process of twisting the head conductor portion of a large turning conductor segment of a pine-needle shape is performed by using an innermost layer ring and an outermost layer ring which are coaxial with each other and rotatable in the circumferential direction to cause an angular shift between them. The innermost layer ring has a radius corresponding to a radial position of the in-slot conductor portion of the innermost layer. The innermost layer ring has a predetermined number of insertion holes angularly arranged so as to correspond to respective in-slot conductor portions of the innermost layer. The outermost layer ring has a radius corresponding to a radial position of the in-slot conductor portion of the outermost layer. The outermost layer ring has a predetermined number of insertion holes angularly arranged so as to correspond to respective in-slot conductor portions of the outermost layer.

Installation of each large turning conductor segment of a pine-needle shape is performed in the following manner. First, the in-slot conductor portions of the innermost layer are inserted into insertion holes of the innermost layer ring. Then, the in-slot conductor portions of the outermost layer are inserted into insertion holes of the outermost layer ring. Next, the head portions of respective large turning conductor segments are fixed together with a holding plate to prevent them from rotating. Then, the innermost layer ring and the outermost layer ring are respectively rotated oppositely by a half pole pitch in the circumferential direction so as to cause an angular shift between them equivalent to one pole pitch. Through this twisting process, the large U-shaped turning conductor segment 331 is obtained as shown in FIG. 2. The holding plate, in this case, relocates in the axial direction as the apex of the head portion of each large turning conductor segment moves toward the side flat surfaces of the coaxial rings in accordance with deformation of the head portion when configured into the U shape from its original pine-needle shape.

2. Conductor Segment Installing Process

Next, the small U-shaped turning conductor segments 332 are pulled out of the insertion holes of the above-described rings. As representatively shown in FIG. 4, the small U-shaped turning conductor segments 332 are installed into the slots 35 of stator core 32 so as to straddle between a position corresponding to the inner middle layer and a position corresponding to the outer middle layer. In this case, the small U-shaped turning conductor segments 332 are assembled together with the above-described holding plate so that the small U-shaped turning conductor segments 332 can be installed into corresponding slots 35 at a time. After accomplishing installation of the small U-shaped turning conductor segments 332 into the slots 35 of stator core 32, the holding plate is removed.

Similarly, the large U-shaped turning conductor segments 331 are pulled out of the insertion holes of the above-described rings. As representatively shown in FIG. 4, the large U-shaped turning conductor segments 331 are installed into the slots 35 of stator core 32 so as to straddle between a position corresponding to the innermost layer and a position corresponding to the outermost layer. In this case, the large U-shaped turning conductor segments 331 are assembled together with the above-described holding plate so that the large U-shaped turning conductor segments 331 can be installed into corresponding slots 35 at a time. After accomplishing installation of the large U-shaped turning conductor segments 331 into the slots 35 of stator core 32, the holding plate is removed.

The process for installing the large U-shaped turning conductor segments 331 and the small U-shaped turning conductor segments 332 into the slots 35 is not limited to the above-described one, and therefore can be variously changed.

3. Tail Portion Twisting Process

Next, the process for twisting the tail conductor portion of the conductor segment 33 inserted in the slot of the stator will be explained hereinafter.

According to this embodiment, the large turning conductor segment 331 includes the outermost layer in-slot conductor portion 331b and the tail conductor portion 331g. The tail conductor portion 331g (which may be referred to as an outer layer side end portion), connected to the outermost layer in-slot conductor portion 331b, is twisted in a predetermined circumferential direction. Furthermore, the large turning conductor segment 331 includes the innermost layer in-slot conductor portion 331a and the tail conductor portion 331f. The tail conductor portion 331f (which may be referred to as an inner layer side end portion), connected to the innermost layer in-slot conductor portion 331a, is twisted in the opposite circumferential direction.

Similarly, the small turning conductor segment 332 includes the inner middle layer in-slot conductor portion 332a and the tail conductor portion 332f. The tail conductor portion 332f (which may be referred to as an inner layer side end portion), connected to the inner middle layer in-slot conductor portion 332a, is twisted in the predetermined circumferential direction. Furthermore, the small turning conductor segment 331 includes the outer middle layer in-slot conductor portion 332b and the tail conductor portion 332g. The tail conductor portion 332g (which may be referred to as an outer layer side end portion), connected to the outer middle layer in-slot conductor portion 332b, is twisted in the opposite circumferential direction.

A sum of the circumferential twist amount of the tail conductor portion 331f and the circumferential twist amount of the tail conductor portion 332f is equivalent to one pole pitch. A sum of the circumferential twist amount of the tail conductor portion 331g and the circumferential twist amount of the tail conductor portion 332g is equivalent to one pole pitch.

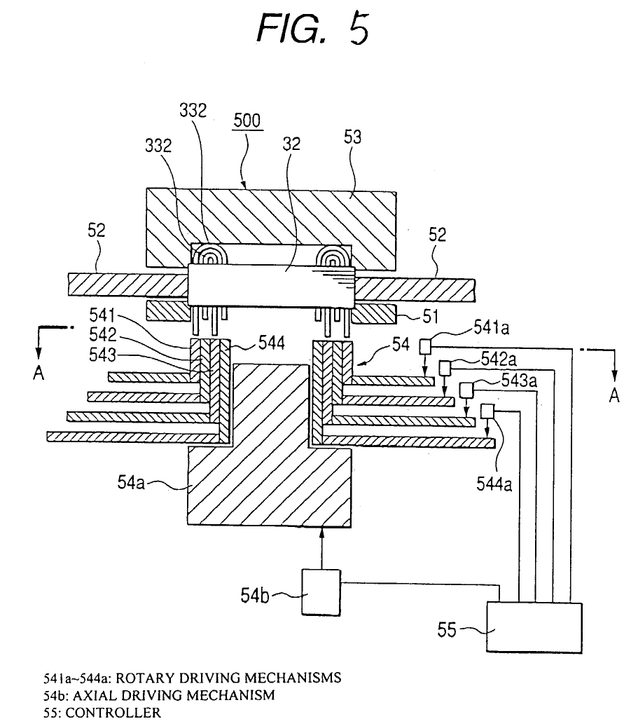

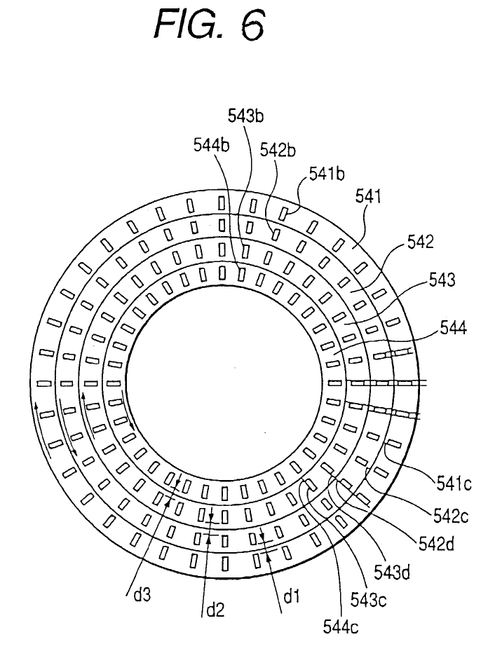

The process for twisting the large turning conductor segment 331 and the small turning conductor segment 332 will be explained in more detail with reference to FIGS. 5 and 6. FIG. 5 is a vertical cross-sectional view schematically showing a stator coil twisting apparatus 500. FIG. 6. is a cross-sectional view taken along a line A-A of FIG. 5.

First, the arrangement of the stator coil twisting apparatus 500 will be explained.

The stator coil twisting apparatus 500 includes a work receiver 51 for receiving an outer peripheral portion of the stator core 32, a damper 52 for regulating the movement of stator core 32 in the radial direction and for holding the stator core 32, a work presser 53 for preventing the stator core 32 from raising upward, a twist shaping unit 54 for twisting the legs of the segment 33 protruding from one end of the stator core 32, an elevating shaft 54a for shifting the twist shaping unit 54 in the axial direction, a plurality of rotary driving mechanisms 541a to 544a for rotating the twist shaping unit 54 in the circumferential direction, an axial driving mechanism 54b for shifting the elevating shaft 54a in the axial direction, and a controller 55 for controlling each of the rotary driving mechanisms 541a to 544a and the axial driving mechanism 54b.

The twist shaping unit 54 includes a total of four cylindrical twisting jigs 541 to 544 which are coaxially disposed, with their top end surfaces being arranged at the same height. The rotary driving mechanisms 541a to 544a independently rotate the corresponding cylindrical twisting jigs 541 to 544. The axial driving mechanism 54b shifts the elevating shaft 54a in the up-and-down direction so that all of the cylindrical twisting jigs 541 to 544 can be integrally raised or lowered.

As shown in FIG. 6, the twisting jigs 541 to 544 have conductor segment insertion holes 541b to 544b, on their top end surfaces, for receiving the distal ends (i.e., joint portions) of the tail conductor portions 331f, 331g, 332f, and 332g of the conductor segment 33 inserted into the slots of the stator core 32. The number of conductor segment insertion holes 541b to 544b is equal to the number of the slots 35 of stator core 32 (refer to FIGS. 3 and 4). The conductor segment insertion holes 541b to 544b are angularly spaced in the circumferential direction at predetermined intervals so as to correspond to the slots 35 of stator core 32. In FIG. 3, a reference numeral 34 represents an insulating resin sheet.

The conductor segment insertion holes 541b to 544b, as shown in FIG. 6, are provided with partition walls 541c to 544c, 542d, and 543d for preventing the conductor segment insertion holes 541b to 544b which are adjacent to each other in the radial direction from communicating with each other. The thickness of respective partition walls 541c to 544c, 542d, and 543d is determined in the following manner. The neighboring partition walls 541c and 542c cooperatively form a gap d1 at the boundary between the outermost layer and the outer middle layer. The neighboring partition walls 542d and 543d cooperatively form a gap d2 at the boundary between the outer middle layer and the inner middle layer. The neighboring partition walls 543c and 544c cooperatively form a gap d3 at the boundary between the inner middle layer and the innermost layer. The gap d2 is set to be larger than the gap d1 or the gap d3.

The stator coil twisting apparatus 500 operates in the following manner.

The stator core 32, with the conductor segments 33 disposed in its slots 35, is placed on the work receiver 51. Next, the outer cylindrical wall of the stator core 32 is fixed with the damper 52. Thereafter, the work presser 53 depresses the upper portion of the stator core 32 as well as the head conductor portions 331c of the large turning conductor segments 331. Thus, the stator core 32 and the conductor segments 33 are surely fixed so as not to move in the up-and-down direction.

After the stator core 32 with the conductor segments 33 installed therein is fixed by using the damper 52 and the work presser 53, the elevating shaft 54a raises the twist shaping unit 54 so that the tail conductor portions 331f, 331g, 332f, and 332g of respective conductor segments 33 are inserted into the conductor segment insertion holes 541b to 544b formed in respective twisting jigs 541 to 544.

The conductor segment insertion holes 541b to 544b can receive only the distal ends (which later become the joint portions) of tail conductor portions 331f, 331g, 332f, and 332g of respective conductor segments 33. As the tail conductor portions 331f, 331g, 332f, and 332g of respective conductor segments 33 are tapered, they can be smoothly inserted into the conductor segment insertion holes 541b to 544b.

After the tail conductor portions 331f, 331g, 332f, and 332g of respective conductor segments 33 are inserted into the conductor segment insertion holes 541b to 544b of the twist shaping unit 54, the twist shaping unit 54 is rotated by the rotary driving mechanisms 541a to 544a and raised or lowered by the axial driving mechanism 54b. The twist shaping unit 54 performs this operation for all of the twisting jigs 541 to 544 simultaneously.

Hereinafter, rotation of the twist shaping unit 54 is explained.

The twisting jigs 541 and 543 are rotated in the clockwise direction by a first angle, while the twisting jigs 542 and 544 are rotated in the counterclockwise direction by a second angle.

Important thing in this case is that the first angle is set to be larger than the second angle by an amount of 50% or more. With this setting, the bending radius is put to elongated portions (except for the joint portions) of the tail conductor portions 331f, 331g, 332f, and 332g of respective conductor segments 33 extending from the outlet of the slots 35 to the inlet of the conductor segment insertion holes 541b to 544b. Accordingly, a large bending radius is put to the tail conductor portions 331g and 332f while a small bending radius is put to the tail conductor portions 331f and 332g.

Thereafter, the twist shaping unit 54 is rotated by the rotary driving mechanisms 541a to 544a and raised by the axial driving mechanism 54b so that the elongated portions of the tail conductor portions 331f, 331g, 332f, and 332g of respective conductor segments 33 extending from the outlet of the slots 35 to the inlet of the conductor segment insertion holes 541b to 544b are maintained to have a constant length. In this case, the tail conductor portions 331f, 331g, 332f, and 332g of respective conductor segments 33 rotate and rise so as to trace an arc locus. Considering spring back deformation of respective conductor segments 33, the operation for twisting the tail conductor portions so as to trace an arc locus is performed until the angle exceeds a regulation angle equivalent to a half pole pitch (T/2) by a predetermined amount.

Furthermore, in addition to the circumferential direction, this twisting process includes an axial shifting of the twisting jigs 541 to 544 which is performed so as to exceed a regulation distance by a predetermined amount. As each conductor segment 33 is already bent at the outlet portion of the slot 35, the conductor segment 33 is not pulled out of the slot 35 when the conductor segment 33 rises.

Thereafter, the axial driving mechanism 54b and the rotary driving mechanisms 541a to 544a are controlled to rotate the twist shaping unit 54 in the opposite direction and lower it. After finishing the twisting process of respective conductor segments 33 in this manner, the twist shaping unit 54 is further lowered to remove the tail conductor portions 331f, 331g, 332f, and 332g of respective conductor segments 33 out of the conductor segment insertion holes 541b to 544b of the twisting jigs 541 to 544. After the conductor segments 33 are removed from the twist shaping unit 54, the rotary driving mechanisms 541a to 544a rotate the twist shaping unit 54 to return it to the original position. Finally, the clamper 52 and the work presser 53 are released from the stator core 32. Then, the stator with the twisted conductor segments 33 is taken out.

Subsequently, neighboring ones of the joint portions 331d, 331e, 332d, and 332e of the tail conductor portions 331f, 331g, 332f, and 332g are welded to obtain a three-phase stator coil having a predetermined turn number.

After all, the above-described twisting process is characterized by first deforming the tail conductor portions of each conductor segment 33 in only the circumferential direction to make the conductor segment 33 incline in the circumferential direction, then deforming the tail conductor portions of each conductor segment 33 in both the circumferential direction and the axial direction to make the conductor segment 33 incline deeply, and thereafter excessively deforming the tail conductor portions of each conductor segment 33 in both the circumferential direction and the axial direction beyond the regulation values to make the conductor segment 33 incline excessively, and finally letting the tail conductor portions of each conductor segment 33 return to the regulation values due to self spring back deformation.

The twist shaping unit 54 causes the shift movement relative to the stator core 32 not only the circumferential direction but also in the axial direction. Hence, it becomes possible to twist the tail conductor portions 331f, 331g, 332f, and 332g of conductor segments 33 so as to trace an arc locus, according to which the length of the tail conductor portions 331f, 331g, 332f, and 332g except for the joint portions 331d, 331e, 332d, and 332e can be kept to a constant value. In other words, the elongated portions of the tail conductor portions 331f, 331g, 332f, and 332g of respective conductor segments 33 extending from the outlet of the slots 35 to the inlet of the conductor segment insertion holes 541b to 544b can be maintained to a constant length. As a result, it becomes possible to prevent the conductor segments 33 from being pulled out of the conductor segment insertion holes 541b to 544b.

Furthermore, only the joint portions 331d, 331e, 332d, and 332e of the conductor segments 33 are inserted into the conductor segment insertion holes 541b to 544b. As described above, this prevents the conductor segments 33 from being pulled out of the conductor segment insertion holes 541b to 544b. Accordingly, it becomes possible to prevent the portions of the conductor segments 33 except for the joint portions 331d, 331e, 332d, and 332e from being damaged or wounded. The joint portions 331d, 331e, 332d, and 332e are free from damage or wound because they are, after being twisted, welded with adjacent joint portions of other conductor segments.

Furthermore, regarding the thickness of respective partition walls 541c to 544c, 542d, and 543d, the gap defined by the partition walls 542d and 543d at the boundary between the outer middle layer and the inner middle layer is set to be larger than the gap defined by the partition walls 541c and 542c at the boundary between the outermost layer and the outer middle layer or the gap defined by the partition walls 543c and 544c at the boundary between the inner middle layer and the innermost layer.

The outermost layer and the outer middle layer are rotated in the opposite directions so as to cause a mutual displacement equivalent to a half pole pitch. The innermost layer and the inner middle layer are rotated in the opposite directions so as to cause a mutual displacement equivalent to a half pole pitch. The conductor segments of the outermost layer and the outer middle layer approach to each other, while the conductor segments of the innermost layer and the inner middle layer approach to each other. The gap between the partition walls 542d and 543d at the boundary between the outer middle layer and the inner middle layer is set to be large. Hence, the clearance between the conductor segment 33 of the outer middle layer and the conductor segment 33 of the inner middle layer is relatively large. On the other hand, the clearance between two conductor segments 33 to be welded each other becomes small. More specifically, the clearance between the conductor segment 33 of the outermost layer and the conductor segment 33 of the outer middle layer becomes relatively small. The clearance between the conductor segment 33 of the innermost layer and the conductor segment 33 of the inner middle layer becomes relatively small. In other words, the clearance between the conductor segments 33 not welded each other is maintained to a relatively large value. This is effective to facilitate the welding process.

Furthermore, the twisting jigs 541, 542, 543, and 544 are exchangeable so as to fit to any type of stator. For example, the slot number of the stator is not limited to 36 slots. Accordingly, by exchanging the twisting jigs 541, 542, 543, and 544, the twist shaping unit 54 is applicable to any type of a stator whose slot number may be 48, 84, 96, or others. It is possible to independently control the rotational amount of the twisting jigs 541, 542, 543, and 544. The axial shift amount of the twist shaping unit 54 is controlled independent of the rotational amount of the twisting jigs 541, 542, 543, and 544. Thus, the twist shaping unit 54 of this embodiment is applicable to various types of stators for performing the twist process appropriately.

4. Welding Process

The welding process will be explained hereinafter.

After the twisting process of the conductor segments is accomplished, the conductor segment 33 of the innermost layer and the conductor segment 33 of the inner middle layer are welded at their distal ends (i.e., the joint portions) as shown in FIG. 2. Similarly, the conductor segment 33 of the outermost layer and the conductor segment 33 of the outer middle layer are welded at their distal ends (i.e., the joint portions). The stator coil 31 is thus accomplished. The practical welding used in this embodiment is, for example, TIG welding, brazing, electron-beam welding, laser welding, or the like.

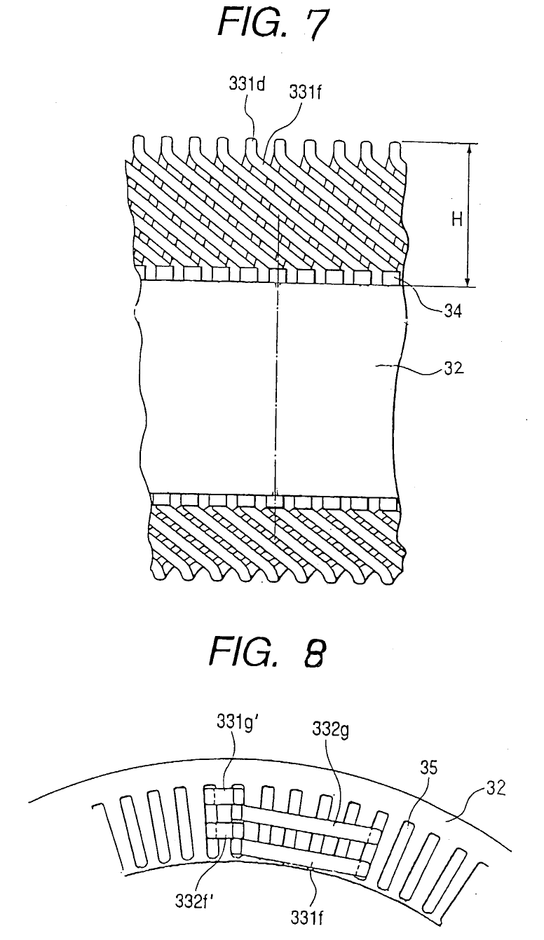

FIGS. 7 and 8 show the stator coil 31 being thus accomplished. However, according to this embodiment, the tail conductor portions 331f and 332g are largely twisted (or inclined) in the circumferential direction compared with the tail conductor portions 331g and 332f.

### Modified Embodiment

According to the above-described embodiment, the stator coil is formed by welding the distal ends of the conductor segments, each having a head portion being configured beforehand into a V shape or a U-shape, at only one side of the stator core. Alternatively, it is possible to weld the conductor segments at both sides of the stator core. In this case, the above-described V-shaped or U-shaped conductor segments can be replaced with later-described oblique L-shaped conductor segments or I-shaped conductor segments to weld them at both sides of the stator core and finally obtain the conductor segments of the present invention.

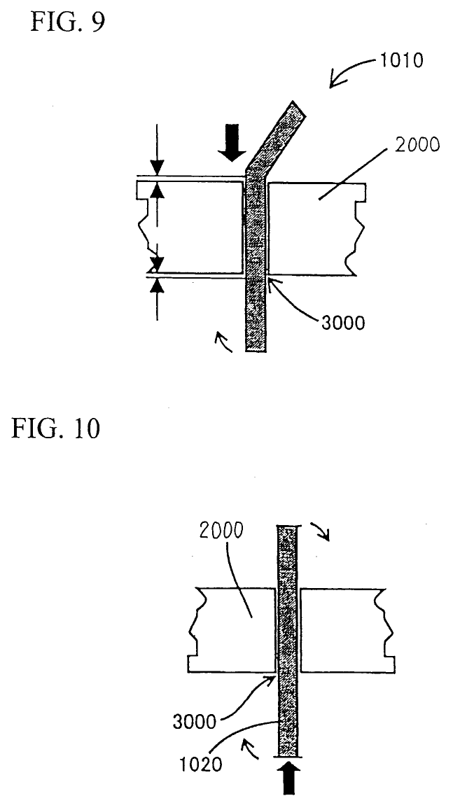

According to a modified embodiment shown in FIG. 9, an oblique L-shaped conductor segment 1010 is inserted into a slot 3000. Then, a leg protruding portion of the oblique L-shaped conductor segment 1010 is bent at the other side of a stator core 2000.

According to a modified embodiment shown in FIG. 10, an I-shaped conductor segment 1020 is inserted into the slot 3000. Then, both protruding ends of the I-shaped conductor segment 1020 are bent at both sides of the stator core 2000.

### Stator Core Arrangement

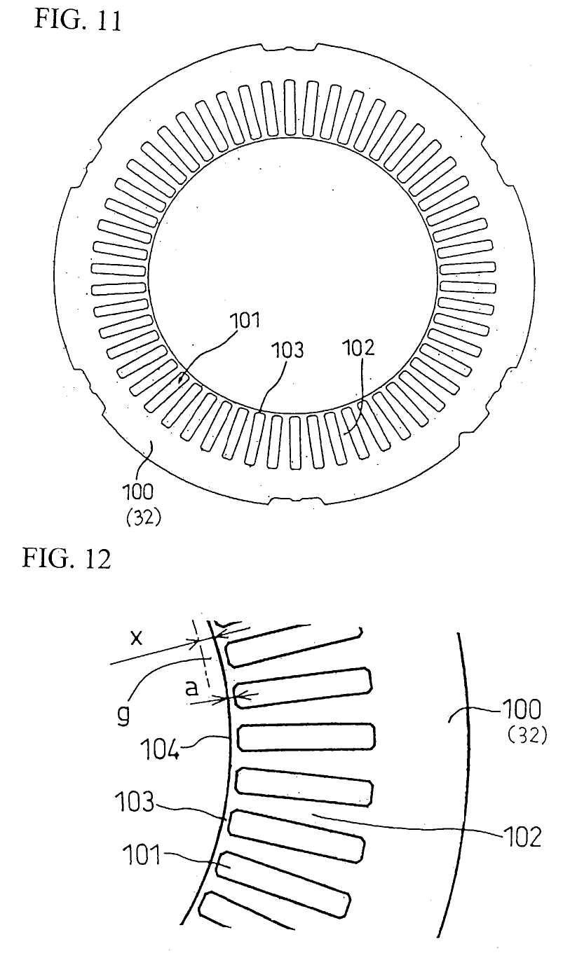

FIGS. 11 and 12 cooperatively show the characteristic arrangement of the stator core of this embodiment.

In FIG. 11, a stator core 100 (corresponding to the stator core 32 shown in FIG. 1) includes numerous slots 101 (corresponding to slots 35 shown in FIGS. 3 and 4) disposed in the circumferential direction at predetermined angular intervals, numerous teeth 102 interposed between adjacent slots so as to extend in the radial directions, and slot closures 103.

The stator core 100 is formed by punching a predetermined number of electromagnetic steel sheets and then laminating them. The slots 101 and the teeth 102 are alternately disposed in the circumferential direction in the vicinity of an inner cylindrical surface 104 of the stator core 100 which faces an outer cylindrical surface of the rotor core 71 (shown in FIG. 1).

Each slot 101 has a cross-sectional shape elongated in the radial direction. The slot closure 103 is located between the radial inner end of the slot 101 and the inner cylindrical surface of. the stator core 100. The slot closures 103 are integral with the teeth 102 and protrude in the circumferential direction from the radial inner end of respective teeth 102. More specifically, in the process of punching each electromagnetic steel plate, the slots 101 are opened so as to leave the teeth 102 and the slot closures 103 integral with the stator core 100 having high magnetic permeability. In this respect, both the teeth 102 and the slot closures 103 have high magnetic permeability. Respective slot closures 103 provide electromagnetic path for connecting the radial inner ends of neighboring teeth 102 located at both sides of each slot 101. In other words, respective slot closures 103 have the function of completely isolating respective slots 101 from the electromagnetic gap g provided between the inner cylindrical surface 104 of the stator core 100 and the rotor core.

With the above-described arrangement, it becomes possible to solve various problems relating to the magnetic resistance of the electromagnetic gap g or in the vicinity of the inner cylindrical surface 104 of the stator core 100, and its variation, or distortion in the magnetic flux distribution, as well as the problems relating to torque variation and noises derived from these problems.

Furthermore, according to the above-described embodiment of the present invention, the thickness ‘a’ of the slot closure 103 in the radial direction is less than a clearance ‘x’ of the electromagnetic gap g (i.e., a radial distance between the inner cylindrical surface 104 of the stator core 100 and the rotor core). This arrangement surely prevents each slot closure from serving as a bypass for the field flux formed by the stator coil or for the magnetic flux generated by the rotor, thereby preventing the performance of the rotary machine from deteriorating.

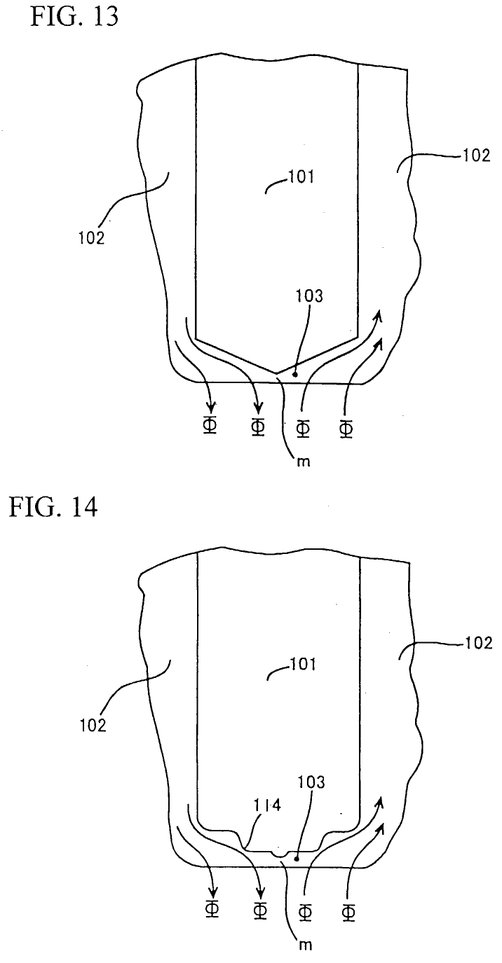

FIG. 13 shows a modified embodiment of the stator core in accordance with the present invention.

According to the stator core shown in FIG. 13, the radial inner end of the slot 101 is configured into a V-shaped or notched wall. The width (i.e., radial size) of slot closure 103 gradually decreases with approaching distance from a circumferential end of the slot 101 toward a circumferential center m of the slot 101. This arrangement effectively reduces the leakage of magnetic flux passing the slot closure 103.

FIG. 14 shows another modified embodiment of the stator core in accordance with the present invention.

According to the stator core shown in FIG. 14, the radial inner end of the slot 101 is configured into a stepped portion 114. The stepped portion 114 is provided at the circumferential center m of the slot 101. The width (i.e., radial size) of slot closure 103 decreases in a stepwise manner with approaching distance from a circumferential end of the slot 101 toward the circumferential center m of the slot 101. This arrangement effectively reduces the leakage of magnetic flux passing the slot closure 103.

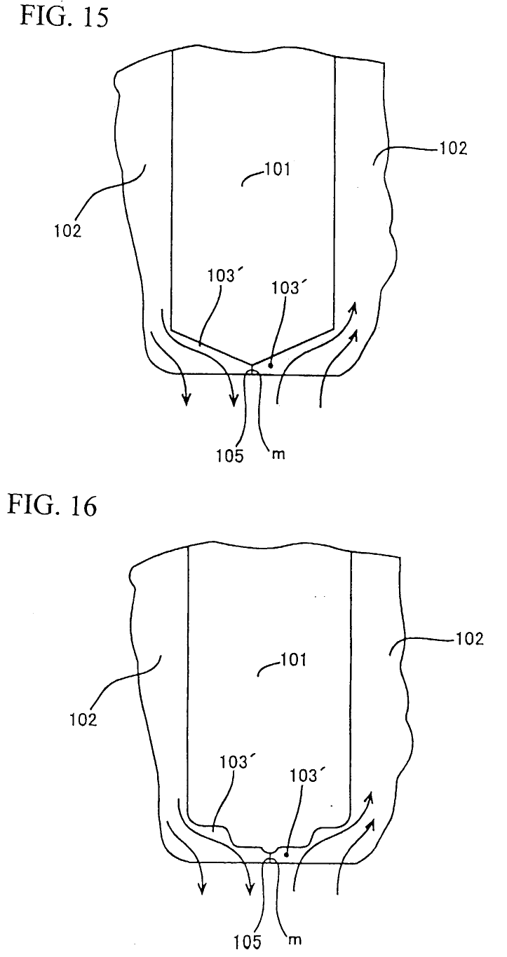

FIGS. 15 and 16 show modified embodiments of the stator cores shown in FIGS. 13 and 14, which are different in that the above-descried slot closure 103 is replaced by a pair of claws 103′ brought into contact with each other to close the slot 101. These embodiments bring substantially the same effects.

According to the above-described embodiments, the stator core is constituted by a plurality of laminated electromagnetic steel sheets. Alternatively, it is possible to form the stator core by rolling an elongated electromagnetic steel plate into a core shape. In this case, the arrangement shown in FIG. 15 or 16 can be preferably employed because the claws 103′ abutting to each other has the capability of adequately releasing a stress acting in the stator core.

As apparent from the foregoing description, the preferred embodiments of the present invention provides a stator for an electric rotary machine including a stator core (32; 100) having slots (35; 101) and teeth (102) alternately arranged in a circumferential direction and disposed in the vicinity of an inner cylindrical surface (104) of the stator core which faces a rotor (2) with a predetermined electromagnetic gap (g), and a stator coil (31) wound around the stator core (32; 100) and inserted into the slots (35; 101). The stator core (32; 100) includes slot closures (103; 103′) integrally formed with the teeth (102) and extending in the circumferential direction from radial inner ends of respective teeth so as to substantially isolate the slots (35; 101) from the electromagnetic gap (g). And, the stator coil (31) includes a plurality of conductor segments (33) inserted into the slots (35; 101), with ends of the conductor segments (33) being sequentially connected at an axially outside of the stator core (32; 100).

The slot closures (103: 103′) and the teeth (102) are integrally formed by using the same material and completely isolate the slots (35; 101) from the electromagnetic gap (g).

The radial size of the slot closures (103; 103′) decreases with approaching distance from a circumferential end of respective slots (35; 101) toward a circumferential center (m) of the slots (35; 101).

The thickness (a) of the slot closures (103; 103′) in the radial direction is less than the clearance (x) of the electromagnetic gap (g).

What is claimed is:

1. A stator for an electric rotary machine comprising:
a stator core having slots and teeth alternately arranged in a circumferential direction and disposed in the vicinity of an inner cylindrical surface of said stator core which faces a rotor with a predetermined electromagnetic gap, and
a stator coil wound around said stator core and inserted into said slots, wherein
said stator core comprises slot closures integrally formed with said teeth and extending in the circumferential direction from radial inner ends of respective teeth so as to substantially isolate said slots from said electromagnetic gap, and
said stator coil comprises a plurality of conductor segments inserted into said slots, with ends of said conductor segments being sequentially connected at an axially outside of said stator core.

2. The stator for an electric rotary machine in accordance with claim 1, wherein said slot closures and said teeth are integrally formed by using a same material and completely isolate said slots from said electromagnetic gap.

3. The stator for an electric rotary machine in accordance with claim 1, wherein a radial size of said slot closures decreases with approaching distance from a circumferential end of respective slots toward a circumferential center of said slots.

4. The stator for an electric rotary machine in accordance with claim 1, wherein a thickness of said slot closures in the radial direction is less than a clearance of said electromagnetic gap.
